(19) United States
(12) Patent Application Publication
(10) Pub. No.: US 2010/0123385 A1
(43) Pub. Date: May 20, 2010

(54) Electroluminescent fibers, methods for their production, and products made using them

(76) Inventors: Willorage Rathna Perera, Raynham, MA (US); Gerald J. Mauretti, Fall River, MA (US)

Correspondence Address: Michael de Angeli;ATTORNEY AT LAW, 60 INTREPID LANE, JAMESTOWN, RI, 02835, US

(21) Appl. No.: 12/292,404

(22) Filed: Nov. 18, 2008

(51) Int. Cl. H01J 1/62; H01J 9/00

(52) U.S. Cl. 313/502; 445/58

(57) ABSTRACT

Electroluminescent fibers comprise two spaced elongated continuous electrical conductors in a matrix of a polymer containing particles of a phosphor. When suitable electrical power is applied to the conductors, the phosphor glows along the length of the fiber. The fibers can be used to make a variety of useful and attractive products.

### FIELD OF THE INVENTION

This invention relates to electroluminescent fibers, that is, elongated members that emit light when an electric current is applied to them, to methods of making such fibers, and to products made employing such fibers.

### BACKGROUND OF THE INVENTION

Generally speaking, electroluminescence (EL) may be defined as the production of visible light by a substance exposed to an electric field without thermal energy production. Typical EL devices includes light-emitting diodes, which are discrete devices that produce light when a current is applied to a doped p-n junction of a semiconductor, as well as EL displays (ELDs) which are matrix-addressed devices that can be used to display text, graphics, and other computer images. EL is also used in lamps and backlights. EL fibers are also disclosed in U.S. Pat. No. 5,869,930 to Baumberg et al, and are commercially available from LyTec Asia Limited, of Hong Kong, China.

More particularly, the typical EL display or lamp essentially comprises a capacitor structure with an organic phosphor, typically a zinc sulphide compound, sandwiched between the electrodes. Application of an AC signal across the electrodes generates a changing electric field within the phosphor particles causing them to emit light. Typical AC drive signals are 60-115 VAC at 50-1000 Hz. In general, higher frequencies increase lamp brightness, but will reduce the lifetime of the lamp, as will higher voltages and temperatures.

The Crosslink company of St. Louis, Mo. uses metal-coated nylon to make an EL fabric. A metal coating, typically nickel, is first applied to a nylon fabric. Then a phosphor material is applied, e.g., by screen printing. This is followed by a dielectric coating, and then a second conductive coating; the second conductive coating and the metal-coated fabric base layer together make up the electrodes. However, both the metal coated nylon and the final conductive coating exhibit low conductivity, limiting the luminosity of the final product. The screen printed product is also less flexible than would be desired, limiting its utility. Crosslink also sells phosphor inks and other products useful in the manufacture of EL devices.

Another well-known source of phosphors, screen-printable electroluminescent inks, and other products useful in manufacture of EL devices as defined above is DuPont Microcircuit Materials, of Research Triangle Park, N.C. Suitable power supplies, providing AC at typical values of 75-140 VAC and 300-1500 Hz responsive to inputs of 6-36 VDC, are available from ENZ-Electronic Ltd. of Gais, Switzerland, among others.

The EL fibers disclosed in the Baumberg patent appear to correspond closely to the products commercially available from LyTec Asia. Several versions are disclosed and available, respectively. For example, the EL fiber described in connection with FIG. 1 of the Baumberg patent comprises a central copper conductor 2, provided in succession with a dielectric layer 4, a layer 6 of phosphor particles in a binder, a sputtered-on transparent metallic layer 8, a coating 10 of grease or the like, and an outer transparent PVC sheath 12. An AC signal is applied between the central conductor 2 and the transparent metallic layer 8, causing the phosphor materials to emit visible light. In other embodiments, further structure is added to improve the conductivity and reliability of the transparent outer conductor, such as the addition of one or more wires wrapped spirally around the transparent metallic layer, to reinforce the transparent electrode and ensure its continuous conductivity. In a particular embodiment shown in FIG. 9, two copper conductors are provided and the AC signal is connected thereacross (see col. 4, lines 56-59); the transparent outer conductors are also provided, for reasons that are not explained. The smallest fiber available from LyTec is 1.2 mm in diameter, and a twin-lead fiber, apparently corresponding to FIG. 9 of the Baumberg patent, is 3.5 mm wide.

While such EL fibers have many uses, they are far too large for many desired uses, such as would be made possible if the fibers were capable of being woven into fabric.

### OBJECTS OF THE INVENTION

Accordingly, it is an object of the invention to provide relatively fine, that is, small-diameter EL fibers that are suitable for processing using existing textile-type technology, which would have many applications.

Still more particularly, it is an object of the invention to provide small diameter, durable EL fibers comprising metal cores of high electrical conductivity and sheaths of polymer material that is highly transparent and of textile grade, that is, suitable for use in fabrics, being undamaged upon being washed in hot water, durable in service, foldable, and the like. Such fibers can be processed in textile equipment so as to be woven, knitted, or braided into fabrics, and consequently offer the potential of producing many new types of products, especially apparel such as intelligent wearable products with improved conformability and comfort, for both military and civilian markets.

Thus, it is an object of the invention to produce light emitting fibers that can be integrated into flexible structures such as fabrics or rollable products, such as light emitting tents, safety clothing, sleeping bags, wearable jackets, and military equipment.

It is a further object of the invention to provide a method of manufacture of EL fibers that is less complicated than the method apparently used to manufacture the EL fibers of the Baumberg patent. As stated therein, the outer transparent conductive layer is to be formed by sputtering, which is generally a slow and costly process. Further, as indicated by the Baumberg patent this conductive layer is generally rather delicate, such that further structure must be provided to ensure its reliability over time.

Small diameter EL fibers according to the invention could be used for numerous decorative and utilitarian purposes; as to the former, EL fibers could be applied to clothing and other objects to provide attractive patterns, and as to the latter could be applied to rain, cycling, boating or other personal gear to make the wearer more readily visible, for safety purposes.

A fine electroluminescent fiber according to the invention could be woven into fabric and used to illuminate items made of fabric; for example, a fabric woven of EL fiber could be used to make tents, awnings, and the like with built-in lighting, simplifying the problem of lighting such structures. Fabric woven of EL fibers could also be used to make identifying indicia that could be applied to larger flexible structures, e.g., to the clothing of a wearer so as to make his or her name or number readily visible even under poor visibility conditions, without impediment of the other requirements of fabric, e.g., light weight, adequate tensile strength, durability in use and in laundering, and the ability to be folded.

EL fibers could also be useful in products such as portable electronics and back lights, lighting for automotive and aircraft applications, safety signs, architectural interior and exterior lighting, to provide lighted outlines for structures such as staircases, for safety purposes, and for many other uses.

In several of these applications it would be very desirable if both of the connections by which the exciting electrical current is to be applied to the EL fiber could be made at one end thereof, so that only one end of the EL fiber would need to be accessible.

Therefore, it is an object of the invention to provide an EL fiber which emits visible light when an electrical signal is applied thereto, preferably wherein both connections can be made at a single end of the fiber, wherein the EL fibers as above can be made according to a simple, low-cost, and reliable method, and wherein the fibers as above are at once sufficiently fine and durable to be suitable for further processing, e.g., weaving into fabric, and for the corresponding end uses.

### SUMMARY OF THE INVENTION

According to the present invention, an EL fiber comprises two parallel conductors with a quantity of EL phosphor in a polymer matrix surrounding them, such that when an AC signal is applied across the two conductors, establishing a time-varying electric field between them, the EL phosphors emit light all along the length of the fiber. Conveniently, a complete circuit including the two conductors need not be made; the power supply can simply be connected across the ends of the two conductors at one end. This greatly simplifies the use of the EL fiber of the invention.

In a preferred embodiment, the EL fiber is formed starting with a precursor comprising two parallel electrical conductors insulated electrically from one another by polymer sheaths. The conductors may be made and sheathed simultaneously, as detailed below, or may be made and sheathed separately. A coating comprising the desired phosphors in powder form in a polymer carrier, typically in emulsion or paste form, is then applied to the precursor, or to the two conductors directly, for example by dip coating. In further embodiments, the conductors may be provided bare and coated with phosphor/polymer material in a single operation performed such that the conductors are spaced apart and electrically isolated from one another. The final diameter of the phosphor-coated product and thus the coating thickness is controlled by passing the coated precursor through a sizing die. This coating is then dried. In most cases it will be desirable to apply a second protective sheathing of a transparent polymer; this can be added in a similar dip-coating process, by coating the polymer-coated wires in UV-curable resin followed by exposure to a UV lamp, by passing the polymer-coated wires through an extruder, or otherwise.

In a further embodiment, a quantity of photoluminescent phosphors may also be added, typically by mixing these with the electroluminescent phosphors. Photoluminescent phosphors absorb light at one frequency and emit light at a lower frequency over time. Thus, if the power to the electroluminescent phosphors is pulsed, the photoluminescent (PL) phosphors will absorb the light emitted by the EL phosphors as long as power is applied; when the power is cut off, and the EL phosphors cease to emit light, the PL phosphors will do so, at a different frequency, providing an interesting and eye-catching variation in appearance.

Other aspects of the invention will appear below.

### BRIEF DESCRIPTION OF THE DRAWINGS

The invention will be better understood if reference is made to the accompanying drawings, in which:

FIG. 1 shows a simplified cross-sectional view of the electroluminescent fiber according to the invention, and illustrates schematically the generation of an electric field E between the conductors thereof, and the consequent emission of photons;

FIG. 2 shows a cross-sectional view of one embodiment of the fiber of the invention;

FIG. 3 shows schematically one embodiment of apparatus for manufacture of the EL fiber according to the invention;

FIG. 4 shows schematically the manufacture of composite yarns, that is, employing one or more of the EL fibers of the invention, in combination with one or more additional fibers provided to impart desired engineering properties to the final fiber; and

FIG. 5 shows a schematic cross-sectional view through such a composite yarn.

### DESCRIPTION OF THE PREFERRED EMBODIMENTS

As described above, it is well known that if EL phosphors are exposed to an electric field, particularly a time-varying electric field resulting from application of an AC signal, they will emit light, that is, photons. FIG. 1 shows how this fact can be employed to provide an EL fiber 20 according to the invention. Two parallel conductors 10 and 12 are spaced from one another so as to be electrically isolated, effectively forming the electrodes of a capacitor. Conductors 10 and 12 are surrounded by a large number of phosphor particles 14 in a matrix 16 of a transparent material, e.g. a clear polymer. In many circumstances it will be preferable to employ a textile grade polymer, as above, so that the product will be suitable for processing and use as are the typical fibers used to manufacture fabrics. If a suitable AC power supply 18 is connected across conductors 10 and 12, a time-varying electric field E will be impressed therebetween, as indicated by dashed lines. This will cause the phosphor particles to emit photons P, such that the fiber effectively glows all along its length.

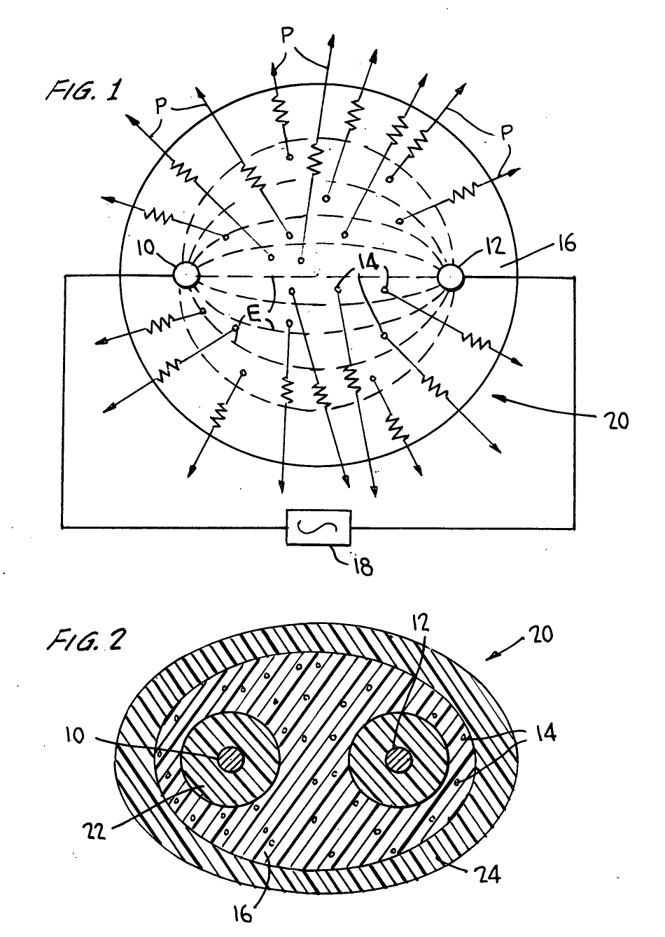

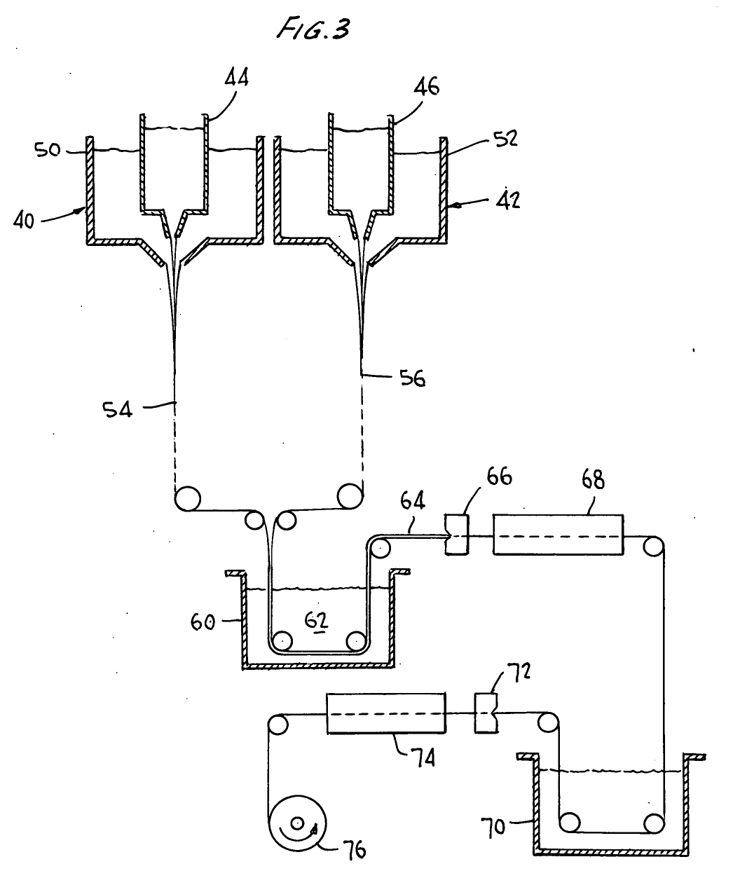

A practical embodiment of the EL fiber 20 according to the invention is illustrated schematically in FIG. 2. Again, conductors 10 and 12 are spaced away from one another, so as to be electrically isolated, forming the electrodes of a capacitor. For convenience in manufacturing, the conductors 10 and 12 may be separately sheathed in layers of an insulative polymer 22. This material need not be transparent. Alternatively, the conductors 10 and 12 may be encased in a single sheath, provided that they are kept spaced from one another. The sheathed conductors are then surrounded by a quantity of phosphor particles 14 in a matrix 16 of a transparent polymer; this in turn may be surrounded by a further protective transparent sheath 24 of the same or a different polymer, with properties chosen in accordance with the desired end use of the fiber, such as abrasion resistance, fire retardancy, ultraviolet reflectivity (to provide long life in outdoor use), lubricity (for ease in weaving), adhesion (for example, a heat-activated adhesive coating may be useful in attaching the EL fiber to various types of products as an intermediate or final step) and the like.

As illustrated in FIG. 1, the intensity of the electric field E is maximised in the direction along a line extending directly between the conductors 10 and 12, such that the maximum light will be emitted for a given combination of weight of phosphor and current applied if the conductors are arranged such that a relatively large proportion of the phosphor particles 14 are disposed directly between the fibers. This would typically be best accomplished if the conductors are separately sheathed and then retained spaced from one another by the matrix 16 in which the phosphors are embedded, as in FIG. 2. However, quite good results have been achieved simply by coating two insulated wires with a coating of phosphor-containing polymer. More specifically, two individual polymer-coated metal wires were passed through a bath of aqueous polymer paste in which phosphor powder was suspended. After passing this precursor through a sizing die, the phosphor/polymer paste was then given an opportunity to dry. This process encapsulated both wires, such that the final product was a single fiber.

More specifically, in successful testing, the conductive cores of the insulated wires (made using the “microwire” process discussed further below) wires were typically 1.25-1.5 mils (that is, 0.00125-0.0015 inches, or 0.032-0.038 millimeters) in diameter, and the overall diameter of the insulated microwires was on the order of 2.5-3 mils. Two such microwires of 2.5 mils outside diameter were coated in phosphor/polymer paste, and drawn through a 10 mil sizing die; after drying, the EL fiber was 7-8 mils in diameter. Such an EL fiber could then be coated with an outer layer of a polymer of desired engineering characteristics, to take a final diameter of 10-15 mils. Such fine fibers are well suited for subsequent processing using conventional textile handling equipment.

FIG. 3 shows schematically an apparatus for and the steps in manufacture of the EL fiber of FIG. 2. In this embodiment, the two conductors are formed and insulated by sheaths of polymer in a single codrawing operation, details of which may be found in copending application Ser. No. 11/976,196, which is commonly assigned and incorporated by reference herein. However, the invention is not to be limited to this particular method of making the conductors, except where the appended claims so specify.

In this embodiment, two crucible assemblies 40 and 42 are provided; each comprises an inner crucible, 44 and 46, respectively, and an outer crucible, 50 and 52, respectively. A conductive metal of lower melting point, such as indium and various alloys thereof, is melted in the inner crucibles, and a higher melting point polymer is melted in the outer crucibles. The lower ends of the crucibles include coaxial orifices. Under the proper processing conditions, “microwires” 54 and 56 each comprising a central conductive element of the metal and an insulative sheath of the polymer may be codrawn, that is, formed in a single processing operation. It will be appreciated that crucibles 40 and 42 can be combined into one polymer-containing crucible containing two inner metal-containing crucibles, from which two insulated conductors might be drawn side by side.

According to this embodiment of the present invention, microwires 54 and 56 (or wires provided in another manner, as above) are passed through a first bath 60, in which the wires are dip-coated with a polymer coating carrying the phosphor. That is, the bath 60 contains a quantity 62 of a thick aqueous-based polymer paste, essentially an emulsion of polymer in water, in which a quantity of the phosphor of interest is suspended in powder form. As the precursor is passed through the bath of paste, the wires are coated thereby. In successful tests, this material was Crosslink Superflex Phosphor Ink, from Crosslink, 950 Bolger Ct, St. Louis, Mo. Alternatively, the phosphor could be dispersed or suspended in a bath of molten polymer, or could be applied in another manner, e.g., by extrusion of a polymer layer containing the phosphor particles over the precursor.

It will be appreciated by those of skill in the art that in the event bare conductors are supplied to the phosphor/polymer bath, so that the polymer forming the matrix within which the phosphor particles are confined also separates and insulates the conductors from one another, guides or the like must be provided to ensure that the conductors do not touch one another in the process.

After exiting bath 60, the fiber 64, comprising the spaced, coated conductors, may be passed through a sizing and/or shaping die 66, so as to ensure a uniform product, with predetermined coating thickness and end product shape and dimensions. For example, as above the intensity of the radiation emitted by the phosphors is a function of the intensity of the electric field E to which they are subjected, and the electric field E is maximized in a direction extending between the conductors. Accordingly, it may be desirable to provide the coated conductors in flat tape form, with the conductors at opposite sides of the tape, so as to maximize the amount of phosphor disposed between the conductors.

After passing through the sizing/shaping die 66, and assuming that an aqueous emulsion is used as the phosphor carrier, the coating may be dried by passing the coated fiber through a suitably-heated tube furnace 68. Since drying is done at a temperature well below the melting point of the polymer coating of the wires 54, 56, the drying step does not affect the wires 54, 56. If the phosphor is applied as a suspension in a bath of molten polymer, the coating is simply cooled to solidify it.

As discussed above, in many circumstances it will be desirable to provide a further outer coating, typically of a transparent polymer, so that the light emitted by the phosphors can be seen. In general, it is highly recommended to provide a protective coating over the phosphor/polymer coated fiber. In particular, humidity can have a detrimental effect on phosphor life. This outer coating can be provided to improve durability of the EL fiber, by providing humidity resistance, wear and tear resistance, chemical resistance, and/or fire resistance, or to provide other desired engineering characteristics or desired further processing characteristics to the fiber, e.g. lubricity for ease in weaving or adhesiveness for ease in placing the fiber in a desired position on a substrate for manufacturing purposes. Such a further outside coating can be applied in a second dip coating step, as exemplified by further bath 70; a second sizing/shaping step may be provided as indicated by die 72, and the second coating may be dried in a second tube furnace 74. Alternatively, the further coating may be made of UV-curable resin; cured by exposure to a suitable UV lamp. The completed fiber 76 is then spooled at 76.

More particularly, provision of fire retardancy could be a very desirable feature in EL yarns intended for use in manufacture of fabric for clothing for military and safety personnel. It is easy to see that, for example, a fireman's jacket that was illuminated by EL, thus providing light without emitting heat, and simultaneously providing fire retardancy would be highly useful. The EL fibers or yarns made of them can be provided with fire retardant capability by several different methods. A) A fire retardant transparent coating can be employed as the outer sheath, encapsulating the EL fibers of the yarn. B) A fire retardant substrate member can be provided at the center of the fiber; if the EL fiber is small enough, a small amount of charring core may halt fire propagation. C) The EL yarn can incorporate a strengthening member pretreated with fire retardant material. D) The conductors can be first wrapped with other fibers comprising fire retardant materials, or coated by fire retardant materials, and the EL coating can then be applied over the fire retardant-coated conductors. E) Fire retardant materials can be added to the polymer coating comprising the EL phosphors.

As indicated above, the parallel conductors can be formed, insulated, coated with the phosphor-laden polymer coating, and provided with a second sheathing layer, all in a single continuous operation. However, it is within the invention to form the insulated conductors separately, spool them up, and later coat them with the phosphor-laden polymer and outer sheath, if desired. It is likewise within the scope of the invention to form an EL fiber by coating conventionally-formed wires, either bare or previously insulated, with the phosphor-laden polymer and outer sheath, if desired. It would also be possible to form an EL fiber by providing an inner conductor, coating this with the phosphor-laden polymer, and wrapping one or more outer conductors (plural outer conductors, if provided, being connected in parallel) around the coated inner conductor; this might be the most efficient way to expose the phosphor to the electric field.

In order to apply power to the conductors of the EL fiber, it is essential to make connections between the conductors and the power supply. If conventionally-sized wires are used as the conductors this presents no problem. However, if the “microwires” described above are used, making connection is more difficult due to the small dimensions of these wires and their relative delicacy. Connections can be made thereto as described in the copending application referred to above: briefly, the insulating polymer sheath can be removed from the tips of the conductors by dipping them in a solvent bath, and connections can then be made by soldering.

Alternatively, a suitable metal, such as indium or gold, can be melted in a suitable crucible. The end of the EL fiber, with the polymer layer(s) in place, is then dipped in the molten metal bath, so as to be coated with the molten metal. The fiber can then be passed through a suitable die to remove excess molten metal. This results in a thin metal cup-shaped cap over the fiber tip, with the metallic core of the microwire touching the center of the cap and the sides of the cap extending over the polymer coating at the tip of the fiber. The relatively larger diameter of the cap makes it comparatively straightforward to attach conductors connecting the core of the microwire to the power supply.

It will be apparent that if the EL fibers according to the invention are to be used in planar form, e.g., if woven into two-dimensional fabric, connections will need to be made to all sections of the fiber that are not continuous; for example, if a cloth woven using the EL fiber of the invention in the transverse direction is cut to shape, the fiber will be severed repeatedly and connections will need to be made to each section individually if they are to be illuminated. This might be a laborious process; possibly it would be more efficient to simply apply a continuous fiber to the fabric surface, using an adhesive, possibly the outermost layer of the fiber itself, as above, to hold the fiber in the desired pattern.

Another possibility would be to weave the EL fiber of the invention into a tubular fabric product using a single fiber; the connection can then be made to one end of this fiber. Shuttle weaving, circular shuttle weaving, and circular knitting are all suitable for producing such tubular members using a single continuous fiber. For example, a tubular fabric member of, for example, one-quarter inch diameter can thus be made. This could then be flattened and applied to a worker's uniform in the shape of a desired indicia, such as a name or number, without requiring cutting of the fabric tube. A single connection would then suffice to illuminate the indicia.

Depending on the application method and desired product, the EL fibers of the invention can be useful without weaving into fabric, and thus without requiring cutting to shape. For example, a yarn comprising a bundle of continuous EL fibers—possibly braided together to form a cohesive member—could be used for architectural lighting purposes, e.g., to mark the stairways in a movie theater. In this situation, a lengthy EL bundle can be secured along the edge of the stairway and powered at one location to mark the steps. A continuous EL yarn can also be used to show borders of any object such as a living room sofa, a hospital bed, table etc. Thus illuminating objects can provide a safety enhancement, e.g., in a senior citizen nursing home especially in the night time.

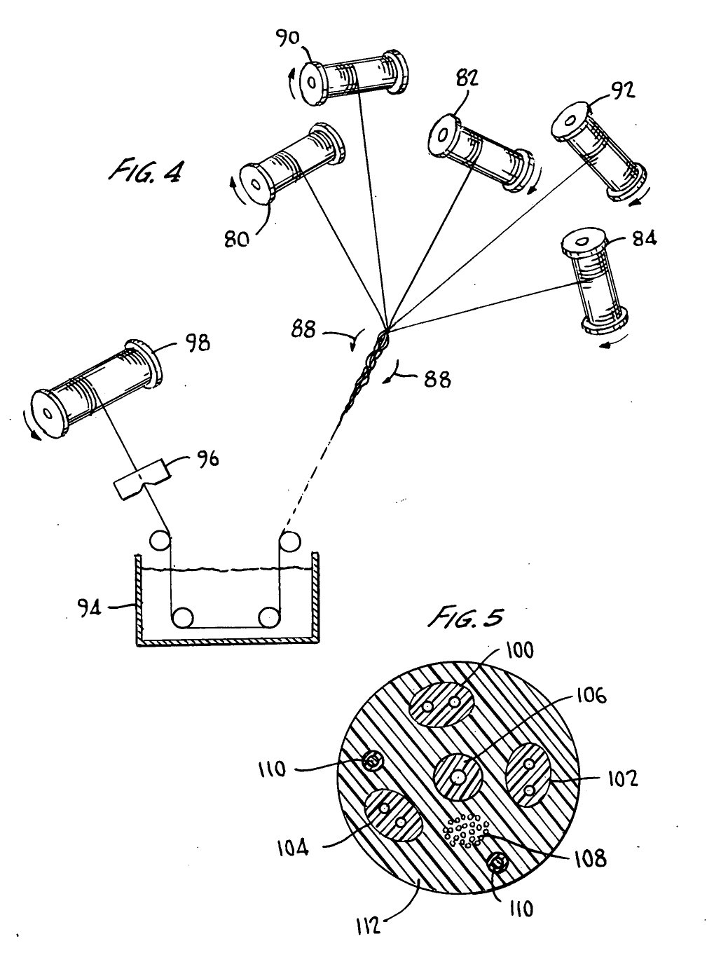

It is also envisioned that the EL fibers as above will usefully be combined with other elongated members so as to manufacture monofilamentary composite fibers or yarns having desired engineering properties. For example, the EL fibers can be processed together with a polyester yarn to give strength to the yarn. Likewise, an optical fiber can be incorporated to provided optical communication capability, or electrical conductors can be incorporated for power and signal carrying capability. FIG. 4 shows schematically how this might be accomplished, and FIG. 5 shows a cross-sectional view of a exemplary composite fiber.

As illustrated in FIG. 4, three EL fibers can be paid off spools 80, 82, 84, together with an optical fiber paid off spool 90 and a polyester strengthening yarn paid off spool 92. The EL fibers can be braided about the optical fiber and polyester yarn, as indicated by arrows 88. Electrical conductors (not shown) could similarly be incorporated. This assemblage of elongated members can then be passed through a bath of molten polymer, as indicated at 94. The coated assemblage can then be passed through a sizing die 96; after this coating has dried, the coated assemblage can be spooled at 98.

As shown by FIG. 5, such a coated assemblage might thus comprise a plurality of EL fibers 100, 102, 104, each comprising two conductors in a matrix of phosphor-containing polymer, an optical fiber 106, a polyester yarn 108, and two electrical conductors 110, all encased in a matrix 112 of a further polymer chosen for desired engineering properties, such as fire retardance, abrasion resistance, lubricity, and others, all as discussed above. This composite fiber could then be employed in a variety of ways, again as discussed above.

Having described the invention, certain advantages and alternatives thereof can now be described in detail.

Advantages of the EL fibers of the invention in general include the following: the fibers are flexible and rollable, and are of light weight, allowing them to be integrated into apparel and equipment worn on one's person; the illumination provided is essentially uniform; the fibers can be formed into complex shapes; the power consumption is low, and there is essentially no heat generation; the fibers exhibit good vibration and impact resistance, and are not susceptible to sudden failures.

The EL fibers produced according to the invention can be based on textile grade polymers, meaning that they are well-suited for processing on textile manufacturing equipment, so that they can be woven, knitted, or braided. As noted above, circular shuttle weaving is advantageous, since this process produces continuous members resembling a hollow braided rope with all of the fibers accessible at one end to make the power supply connections.

If the microwire process of Ser. No. 11/976,196 is to be used to form the conductors, then the EL fibers will comprise textile grade polymers and highly conducting soft metal. This results in fibers with properties comparable to those of typical textile yarns, e.g. conformability and comfort.

As compared to the Crosslink method described above, which employs a metal-coated fabric substrate, fabrics woven of the EL fibers of the invention comprise continuous conductors. Thus the conductivity and hence the luminosity of the product made according to the invention is far superior to the Crosslink fabric. Further, fabric woven of the fibers of the invention would be luminous on both sides, and would also be more pliable than the Crosslink fabric. Further, because the metal is used in small quantities the end product can be price competitive.

As compared to the LyTec fibers, as described in the Baumberg patent, which are apparently of 1.2 mm minimum diameter, the fibers made according to the invention are much finer. In particular, the process of making “microwires” by codrawing the conductors in polymer sheaths according to copending Ser. No. 11/976,196, provides an extremely fine wire of on the order of 0.001 inches, that is, 1 mil, or 25.4 μm (that is, 0.0254 mm) diameter. EL fibers formed using the microwires according to the present invention are consequently far finer than the Baumberg fibers. In turn this allows the fibers of the invention to be employed in many applications for which the Baumberg/LyTec fibers are simply unsuitable, especially in processes wherein the fibers of the invention are processed using conventional textile-industry equipment and techniques.

Furthermore, the method of manufacture of EL fibers according to the present invention is much simpler and therefore to be preferred over the Baumberg method. As noted above, the Baumberg fibers require an inner conductor to be coated in succession with a dielectric layer, a phosphor-containing layer, a transparent metallic layer, a grease layer, and an outer polymer sheath. The Baumberg patent is directed largely to addressing problems arising due to porosity in the phosphor-containing layer and to fragility of the transparent metallic layer.

These problems are avoided according to the present invention by providing the phosphor in a polymer matrix, which is essentially nonporous when dried. As noted, preferably the conductors and the phosphor/polymer layer are further sheathed in a outer polymer layer; this seals the phosphor/polymer matrix, and protects it against any problems (such as incursion of humidity) that might otherwise be engendered by porosity. Further, the EL fibers of the invention comprise separate metallic conductors rather than a delicate and costly transparent metallic layer as one of the conductors, as in Baumberg, such that better and more reliable conductivity is ensured. The process of the present invention also avoids the necessity of the grease layer, provided in Baumberg primarily to retain liquid filling the pores in the phosphor-containing layer, but also useful in protecting the transparent metal layer in bending, to provide a moisture barrier, and to allow stripping of the outer sheath without damaging the transparent metal layer; see col. 3, line 38-col. 4, line 18.

Various polymers and combinations of them can be employed as the phosphor-bearing layer and the outer protective sheath of the EL fibers of the invention, depending on the characteristics desired in the final product. Presuming that the phosphor-bearing layer is made with textile grade polymers, the final product can be further protected with high performance transparent polymers giving added advantages. In particular, the invention has been successfully tested using fluoropolymers so as to improve the usability of the end product in extreme or abusive conditions. For example, the fluoropolymers provide high temperature, abrasion, and cut resistance, thus providing military usability; the fluoropolymers also offer good chemical and solvent resistance. It may also be possible to incorporate flame retardant capability into the polymer coating, as discussed above.

Materials of high dielectric constant (such as mica powder, or a polarizable material such as barium or titanium oxide) can be added to the polymer-bearing polymer layer so that the capacitance between the two conductors is enhanced; this would allow application of higher voltage to a fiber of given dimension, thus enhancing luminescence.

As discussed above, a photoluminescent phosphor (sometimes referred to as “night glow powder”) can also be added to the coating bath so that the EL fiber will glow even after the power is shut off. If the power setting is set to flash (rather than continuous), this could allow the color of the emitted light to change, and might have further advantages.

In addition to application of the phosphor/polymer material by standard coating methods such as dip coating, as discussed above, it can also be applied using ink jet printing or simply spraying the phosphor material on to the microwires. It is also possible that phosphor particles can simply be added to the molten polymer bath in crucibles 40 and 42. Still further, a single polymer can be selected to act as the dielectric medium, the carrier matrix for the phosphor, and the protective coating. Such a process eliminates many steps including the final protective coating application.

An EL fiber may consist of as few as two microwires coated with a polymer layer including the EL phosphor. However, the high speed weavability of these wires may be questionable due to the relatively low strength of microwires. In addition, making connections can be problematic unless micro connectors are used. These problems can be overcome by combining plural microwires (say 15 wires) with 500 denier polyester yarns. The polyester yarn provides the required strength for high speed weaving, while the provision of plural microwires facilitates the use of less sophisticated connectors. For example, the ends of the individual microwire fibers can be dipped into molten metal, as above, to form a conductive cap on the end of each fiber in contact with its central core. Half of the caps can then be soldered to one another and to a first power conductor, and the other half treated similarly, being soldered to the other power conductor. A polyester yarn can be combined with microwires having been previously phosphor-coated in a separate process, or a single composite fiber can be made by wrapping two or more coated conductors around the multifilament polyester yarn, and then applying the phosphor coating overall.

An inner/outer crucible system could also be designed whereby a fiber comprising two microwires and a central substrate (e.g., 500 denier polyester yarn or even an optical fiber) can be produced in one step. A system having two inner metal discharging crucibles within an outer crucible for the polymer, and having a center-substrate guiding pipe extending therethrough would allow introduction of any desired central member between two coated-metal microwires. For example, a central polyester yarn would provide needed tensile strength to the microwires. Provision of a central optical fiber would provide light transmitting properties. Typically, such a composite fiber would be coated with phosphor/polymer material followed by a protective coating, so that the final product will have EL properties as well. By incorporating different substrate yarns, different engineering properties can be integrated to the EL fiber. For example, a central optical fiber can be used as a digital signal transmission medium, while the phosphor/polymer coated conductive microwires would provide EL light emission. Additional conductive wires could also be incorporated to transmit electrical signals.

Still further, even more complicated composite fibers can be made using multi-chambered crucibles, perhaps having concentric inner and outer crucibles, so that two outer chambers can be used to produce microwires, the center chamber can be used to introduce a center substrate (for example, a multifilament polymer yarn or optical fiber) and additional chambers can be used to introduce polymers exhibiting further desired engineering properties (e.g., pressure sensitive adhesive, fire retardant, sensing particles, retroreflective beads or hot melt adhesive). The resulting fiber can be designed to exhibit multiple useful engineering properties such as electroluminescence, retroreflectivity, power carrying capabilities, electrical conductivity for analog or digital signal transmission, optical properties, e.g., for digital signal transmission, to have a pressure sensitive surface, specific property sensing capability, e.g., for sensing heat, bioactive agents, the presence of explosive vapors, and others.

A process similar to circular shuttle weaving, circular knitting (as used to make tubular garments), or standard shuttle weaving can be employed to incorporate a continuous EL yarn throughout a fabric. This process may require only a single connector to illuminate the whole fabric. For example, a tubular woven EL fabric as discussed above can be used as a patch that can be affixed to a garment (e.g., to serve as a self-illuminated name badge) or can be used as a part of the end product (e.g., a 4″ wide EL band could be incorporated into a safety jacket to provide a self-illuminated identifying mark).

Many types of power supplies useful for driving an EL fiber are available. Typically these will comprise DC to AC inverters, allowing the EL fiber to be driven from a small battery. Typical inverter outputs are 60-115 V AC at 50-1000 Hz; the higher the frequency, the greater the brightness. However, it is recommended to use 80-115 V at 400 Hz to prolong the life of the product.

Finally, the invention also includes all manner of products made using the EL yarns of the invention, as described above. Such products can serve both civilian and military markets. For example, fabric products made using the EL fibers of the invention, either entirely or in combination with other materials, may include rollable light emitting tents, jackets, sleeping bags, back panels, decorative panels, safety wear, fashion wear, soft lighted beddings, and others. Products made using the EL fibers of the invention having been woven into tubular form, to simplify connection, may be used to make a wide variety of indicia and the like. The fibers can also be used directly for functional purposes, such as environmental lighting, e.g., such as indicators for door or obstruction locations, safety lighting for stairways or pathways, or as decorative lighting, e.g., accenting the shapes of objects. Many additional products might all be made using EL fibers according to the invention. In general the EL fibers of the invention are inexpensive to manufacture, and are efficient sources of light, since they do not emit appreciable heat.

The invention thus includes the electroluminescent fibers per se, the method of their manufacture, and products made using them.

While several preferred embodiments of the invention have been shown and discussed in detail, the invention should not be limited thereby, but only by the following claims.

What is claimed is:

1. An electroluminescent fiber, comprising two spaced parallel elongated electrical conductors, electrically isolated from one another, and at least partially surrounded by a polymer matrix in which a quantity of electroluminescent phosphor particles are confined.

2. The fiber of claim 1, further comprising an outer layer of the same or a different polymer.

3. The fiber of claim 2, wherein the material(s) of said outer sheath is chosen to provide desired engineering properties to the fiber.

4. The fiber of claim 3, wherein said engineering properties can include one or more of fire retardancy, abrasion resistance, lubricity, adhesiveness, humidity resistance, and chemical resistance.

5. The fiber of claim 1, wherein a quantity of photoluminescent phosphors are also confined in the polymer matrix.

6. Products made using the fiber of claim 1.

7. The products of claim 6, comprising a yarn comprising at least one electroluminescent fiber and a further elongated member provided to impart desired engineering properties to the yarn.

8. The products of claim 7, wherein a polyester member is provided to strengthen the yarn.

9. The products of claim 7, wherein a fiber optic member is provided to impart communication capability.

10. The products of claim 7, wherein one or more electrical conductor members are provided to impart signal carrying capability.

11. A yarn made comprising a plurality of the fibers of claim 1.

12. The yarn of claim 11, further comprising a polyester yarn.

13. A method for making an electroluminescent fiber comprising two spaced parallel elongated conductors, electrically isolated from one another, and at least partially surrounded by a polymer matrix in which a quantity of electroluminescent phosphor particles are confined, comprising the steps of:
providing two continuous elongated conductors;
coating the conductors with a liquefied polymer material in which are suspended particles of a desired electroluminescent phosphor, such that the conductors are precluded from contacting one another; and
allowing the polymer coating to solidify.

14. The method of claim 13, wherein said polymer coating is applied by passing the conductors through a bath of an aqueous paste comprising a polymer with particles of the desired electroluminescent phosphor dispersed therein, and wherein the polymer coating is solidified by drying.

15. The method of claim 13, wherein said polymer coating is applied by passing the conductors through a bath of molten polymer with particles of the desired electroluminescent phosphor dispersed therein, and wherein the polymer coating is solidified upon cooling.

16. The method of claim 13, wherein said conductors having had said polymer coating applied thereto are passed though a sizing die before solidification.

17. The method of claim 13, wherein a quantity of particles of photoluminescent phosphors are also suspended in the polymer matrix.

18. The method of claim 13, wherein the conductors are each covered with an insulative sheath prior to being coated by said molten polymer.

19. The method of claim 13, wherein said conductors are formed simultaneously with their respective sheaths.

20. The method of claim 19, wherein said conductors and their respective sheaths are formed by codrawing an elongated member of a low melting point metal within a sheath of a higher melting point polymer.

21. The method of claim 20, wherein said conductors are on the order of 0.001 inches in diameter, and the fiber comprising said conductors having been coated with a solidified polymer coating in which phosphor particles are dispersed is on the order of 0.007-0.010 inches in diameter.

22. The method of claim 13, comprising the further step of providing at least one further outer sheath of the same or one or more different polymers.

23. The method of claim 22, wherein the material(s) of said outer sheath is chosen to provide desired engineering properties to the fiber.

24. The method of claim 23, wherein said engineering properties can include one or more of fire retardancy, abrasion resistance, lubricity, adhesiveness, humidity resistance, and chemical resistance.

25. The method of claim 13, comprising the further step of manufacturing a yarn comprising at least one fiber made according to the method of claim 13 and a further elongated member provided to impart desired engineering properties to the yarn.

26. The method of claim 25, wherein a polyester member is provided to strengthen the yarn.

27. The method of claim 25, wherein a fiber optic member is provided to impart communication capability.

28. The method of claim 25, wherein one or more electrical conductor members are provided to impart signal carrying capability.

29. The method of claim 13, comprising the further steps of manufacturing a yarn comprising a plurality of the fibers made using the method of claim 13.

30. Products made using the method of claim 13.
